(19) United States
(12) Patent Application Publication
(10) Pub. No.: US 2022/0377295 A1
(43) Pub. Date: Nov. 24, 2022

(54) PROJECTION APPARATUS, PROJECTION METHOD, AND CONTROL PROGRAM

(71) Applicant: FUJIFILM Corporation, Tokyo (JP)

(72) Inventors: Tomonori MASUDA, Saitama-shi (JP); Akihiro ISHIZUKA, Saitama-shi (JP); Kazuki ISHIDA, Saitama-shi (JP); Kazuki INOUE, Saitama-shi (JP)

(73) Assignee: FUJIFILM Corporation, Tokyo (JP)

(21) Appl. No.: 17/881,055

(22) Filed: Aug. 4, 2022

Related U.S. Application Data
(63) Continuation of application No. PCT/JP2021/003429, filed on Jan. 29, 2021.

(30) Foreign Application Priority Data
Feb. 26, 2020 (JP) 2020-030816

(51) Int. Cl. H04N 9/31

(52) U.S. Cl. CPC H04N 9/3185; H04N 9/3147

(57) ABSTRACT

A projection apparatus projects a first image projected by a first projection portion and a second image projected by a second projection portion in a partially overlapping manner, and includes: a processor configured to perform a projection control on a first region of the first image set as an overlapping region with the second image and a second region of the second image set as an overlapping region with the first image, and the processor is configured to: in a case where a first operation of providing an instruction to change the first region and the second region is received, perform at least one of: a control of projecting the first image; or a control of projecting the second image; and in a case where a second operation of providing an instruction to confirm the first region is received, finish the control corresponding to the first operation.

### CROSS REFERENCE TO RELATED APPLICATION

This is a continuation of International Application No. PCT/JP2021/003429 filed on Jan. 29, 2021, and claims priority from Japanese Patent Application No. 2020-030816 filed on Feb. 26, 2020, the entire disclosures of which are incorporated herein by reference.

### BACKGROUND OF THE INVENTION

### 1. Field of the Invention

The present invention relates to a projection apparatus, a projection method, and a computer readable medium storing a control program.

### 2. Description of the Related Art

JP2014-81412A discloses a user interface for designating a range of a duplicate region by considering, in advance, a case where a duplicate region is not known (cannot be assumed) in a pixel region.

### SUMMARY OF THE INVENTION

One embodiment according to the disclosed technology provides a projection apparatus, a projection method, and a computer readable medium storing a control program that efficiently set an overlapping region of respective images projected from a plurality of projection portions.

A projection apparatus according to an aspect of the present invention is a projection apparatus that projects a first image projected by a first projection portion and a second image projected by a second projection portion in a partially overlapping manner, the projection apparatus comprising a processor configured to perform a projection control on a first region of the first image set as an overlapping region with the second image and a second region of the second image set as an overlapping region with the first image, in which the processor is configured to, in a case where a first operation of providing an instruction to change the first region and the second region is received, perform at least any of a control of projecting the first image from the first projection portion by performing the projection control corresponding to the received first operation on the first region or a control of projecting the second image from the second projection portion by performing the projection control corresponding to the received first operation on the second region, and in a case where a second operation of providing an instruction to confirm the first region is received, finish the control corresponding to the first operation.

A projection method according to another aspect of the present invention is a projection method by a projection apparatus that projects a first image projected by a first projection portion and a second image projected by a second projection portion in a partially overlapping manner, the projection method comprising, by a processor of the projection apparatus configured to perform a projection control on a first region of the first image set as an overlapping region with the second image and a second region of the second image set as an overlapping region with the first image, performing, in a case where a first operation of providing an instruction to change the first region and the second region is received, at least any of a control of projecting the first image from the first projection portion by performing the projection control corresponding to the received first operation on the first region or a control of projecting the second image from the second projection portion by performing the projection control corresponding to the received first operation on the second region, and finishing, in a case where a second operation of providing an instruction to confirm the first region is received, the control corresponding to the first operation.

A control program stored in a computer readable medium according to still another aspect of the present invention is a control program of a projection apparatus that projects a first image projected by a first projection portion and a second image projected by a second projection portion in a partially overlapping manner, the control program causing a processor of the projection apparatus to execute a process, the processor being configured to perform a projection control on a first region of the first image set as an overlapping region with the second image and a second region of the second image set as an overlapping region with the first image, the process comprising performing, in a case where a first operation of providing an instruction to change the first region and the second region is received, at least any of a control of projecting the first image from the first projection portion by performing the projection control corresponding to the received first operation on the first region or a control of projecting the second image from the second projection portion by performing the projection control corresponding to the received first operation on the second region, and finishing, in a case where a second operation of providing an instruction to confirm the first region is received, the control corresponding to the first operation.

According to the present invention, a projection apparatus, a projection method, and a computer readable medium storing a control program that can efficiently set an overlapping region can be provided.

### BRIEF DESCRIPTION OF THE DRAWINGS

FIG. 1 is a schematic diagram illustrating a schematic configuration of a projection apparatus 10 that is an embodiment of a projection apparatus according to an embodiment of the present invention.

FIG. 2 is a schematic diagram illustrating an example of an internal configuration of a first projection portion 1a and a second projection portion 1b illustrated in FIG. 1.

FIG. 3 is a schematic diagram illustrating an exterior configuration of a projection portion 1.

FIG. 4 is a schematic cross-sectional view of an optical unit 106 of the projection portion 1 illustrated in FIG. 3.

FIG. 5 is a flowchart illustrating an example of processing of receiving a setting of an overlapping region by a control device 4.

FIG. 6 is a diagram (Part 1) illustrating a specific example of a projection control corresponding to the setting of the overlapping region.

FIG. 7 is a diagram (Part 2) illustrating the specific example of the projection control corresponding to the setting of the overlapping region.

FIG. 8 is a diagram (Part 3) illustrating the specific example of the projection control corresponding to the setting of the overlapping region.

FIG. 9 is a diagram illustrating an example of a setting screen of a positional relationship between a first image 7a and a second image 7b.

FIG. 10 is a diagram illustrating an example of a user interface for receiving a change operation and a confirmation operation from a user.

FIG. 11 is a diagram illustrating another example of the user interface for receiving the change operation and the confirmation operation from the user.

FIG. 12 is a diagram illustrating an example of guide information for providing a guide for a method of the change operation.

FIG. 13 is a diagram illustrating an example of the projection apparatus 10 including three or more projection portions.

FIG. 14 is a flowchart illustrating an example of processing of receiving a setting of an overlapping region by the projection apparatus 10 including three projection portions.

FIG. 15 is a diagram illustrating an example of a setting screen on which the projection apparatus 10 receives a designation of a combination of projection portions of a setting target.

FIG. 16 is a flowchart illustrating an example of processing of receiving a setting of an overlapping region by the projection apparatus 10 including N projection portions.

### DESCRIPTION OF THE PREFERRED EMBODIMENTS

In a case of making respective images projected by a plurality of projection portions partially overlap, it is desirable to perform a projection control, such as a control of decreasing brightness, for suppressing weirdness of an overlapping region in the overlapping region of the respective images. In order to do so, the overlapping region of respective images projected from the plurality of projection portions needs to be set on an apparatus side. However, in the technology of the related art, the overlapping region of respective images projected from the plurality of projection portions cannot be efficiently set.

For example, in JP2014-81412A, while providing the user interface for designating the range of the duplicate region is disclosed, what kind of user interface is to be specifically provided in order to designate the range of the duplicate region is not disclosed.

Regarding this point, a configuration of projecting a cursor or the like for a user to provide an instruction for an overlapping region, receiving a change operation of moving the cursor or the like from the user, and then, in a case where the user performs a confirmation operation, setting a region currently provided as an instruction using the cursor or the like as the overlapping region and performing a projection control is considered.

However, in such a configuration, a result of the change operation is not reflected on the projection control until the user performs the confirmation operation. Thus, it is difficult for the user to imagine the result of the change operation. For example, even in a case where the cursor or the like is pointed to an end part of the overlapping region that is bright because of overlapping between two projection images, it is difficult to visually recognize that the cursor or the like completely matches the end part of the overlapping region. Thus, the overlapping region cannot be efficiently set.

Hereinafter, an embodiment of the present invention for solving these problems will be described with reference to the drawings.

<Schematic Configuration of Projection Apparatus 10 That Is Embodiment of Projection Apparatus According to Present Invention>

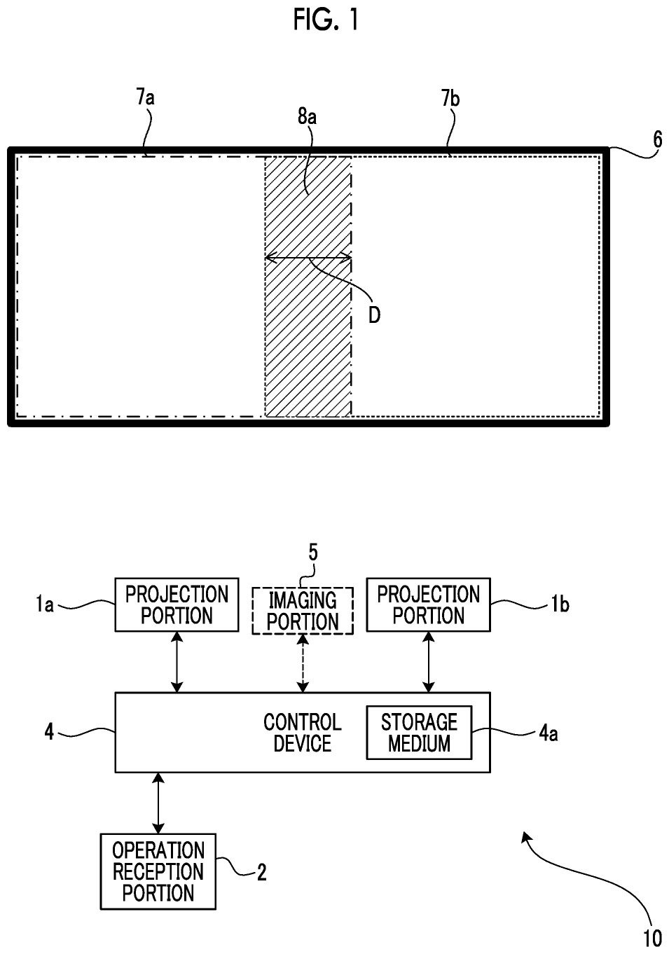

FIG. 1 is a schematic diagram illustrating a schematic configuration of a projection apparatus 10 that is an embodiment of a projection apparatus according to the present invention.

The projection apparatus 10 comprises a first projection portion 1a and a second projection portion 1b, a control device 4, an imaging portion 5, a screen 6, and an operation reception portion 2. Each of the first projection portion 1a and the second projection portion 1b is configured with, for example, a liquid crystal projector or a projector using liquid crystal on silicon (LCOS). Hereinafter, each of the first projection portion 1a and the second projection portion 1b will be described as a liquid crystal projector.

The control device 4 is a device including a control portion configured with various processors, a communication interface (not illustrated) for communicating with each portion, and a storage medium 4a such as a hard disk, a solid state drive (SSD), or a read only memory (ROM) and generally controls the first projection portion 1a and the second projection portion 1b, the operation reception portion 2, and the imaging portion 5.

Examples of the various processors of the control portion of the control device 4 include a central processing unit (CPU) that is a general-purpose processor performing various processing by executing a program, a programmable logic device (PLD) such as a field programmable gate array (FPGA) that is a processor having a circuit configuration changeable after manufacturing, or a dedicated electric circuit such as an application specific integrated circuit (ASIC) that is a processor having a circuit configuration dedicatedly designed to execute specific processing.

More specifically, a structure of these various processors is an electric circuit in which circuit elements such as semiconductor elements are combined. The control portion of the control device 4 may be configured with one of the various processors or may be configured with a combination of two or more processors of the same type or different types (for example, a combination of a plurality of FPGAs or a combination of a CPU and an FPGA).

The imaging portion 5 comprises an imaging element such as a charged coupled device (CCD) image sensor or a metal oxide semiconductor (MOS) image sensor that images a subject through an imaging optical system, and images the screen 6. A captured image captured by the imaging portion 5 is input into the control device 4. The imaging portion 5 may be omitted in the projection apparatus 10.

The operation reception portion 2 detects an instruction (user instruction) from a user by receiving various operations from the user. The operation reception portion 2 may be a button, a key, a joystick, or the like provided in the control device 4 or a reception portion or the like that receives a signal from a remote controller for remotely operating the control device 4.

The first projection portion 1a and the second projection portion 1b, the control device 4, and the operation reception portion 2 are implemented by, for example, one device. Alternatively, the first projection portion 1a and the second projection portion 1b, the control device 4, and the operation reception portion 2 may be implemented by a plurality of devices that cooperate by communicating with each other.

The screen 6 is a projection object having a projection surface on which a projection image is displayed by the first projection portion 1a and the second projection portion 1b. In the example illustrated in FIG. 1, the projection surface of the screen 6 is rectangular. Upper, lower, left, and right sides of the screen 6 in FIG. 1 are upper, lower, left, and right sides of the actual screen 6.

For example, the projection apparatus 10 displays a laterally long image on the screen 6 by projecting a divided image from the first projection portion 1a, projecting a divided image from the second projection portion 1b, and connecting the two divided images.

A first image 7a illustrated by a dot dashed line is an image projected to the screen 6 by the first projection portion 1a. A second image 7b illustrated by a broken line is an image projected to the screen 6 by the second projection portion 1b. In the example illustrated in FIG. 1, each of the first image 7a and the second image 7b is rectangular.

In addition, the projection apparatus 10 projects the first image 7a and the second image 7b in a partially overlapping manner. In the example illustrated in FIG. 1, an overlapping region 8a illustrated by diagonal lines is a region in which the first image 7a overlaps with the second image 7b. In the overlapping region 8a, the first image 7a and the second image 7b are displayed with brightness thereof added to each other. Thus, projection results in weird image display.

Regarding this point, the projection apparatus 10 performs a projection control such as decreasing brightness on parts of the first image 7a and the second image 7b overlapping with each other. As an example, the projection apparatus 10 performs the projection control of decreasing brightness by half on each of a first region of the first image 7a set as an overlapping region with the second image 7b and a second region of the second image 7b set as an overlapping region with the first image 7a. Accordingly, the weirdness in the overlapping region 8a can be suppressed.

In addition, as described above, in a case of displaying the laterally long image by connecting the first image 7a and the second image 7b as the two divided images, the projection apparatus 10 performs the projection control of generating the two divided images such that the overlapping region of each of the first image 7a and the second image 7b is the same image.

As in the example illustrated in FIG. 1, in a case where the first image 7a and the second image 7b each are rectangles having the same height and are arranged in a lateral direction, an overlapping width D that is a width of the overlapping region 8a can be set in the projection apparatus 10 as the overlapping region 8a.

That is, by setting a correct overlapping width D in the projection apparatus 10, the projection apparatus 10 can recognize a region of the first image 7a having the overlapping width D from an end part of the first image 7a on the second image 7b side (a right side in FIG. 1) as the first region which is the overlapping region with the second image 7b, and perform the projection control. In addition, the projection apparatus 10 can recognize a region of the second image 7b having the overlapping width D from an end part of the second image 7b on the first image 7a side (a left side in FIG. 1) as the second region which is the overlapping region with the first image 7a, and perform the projection control.

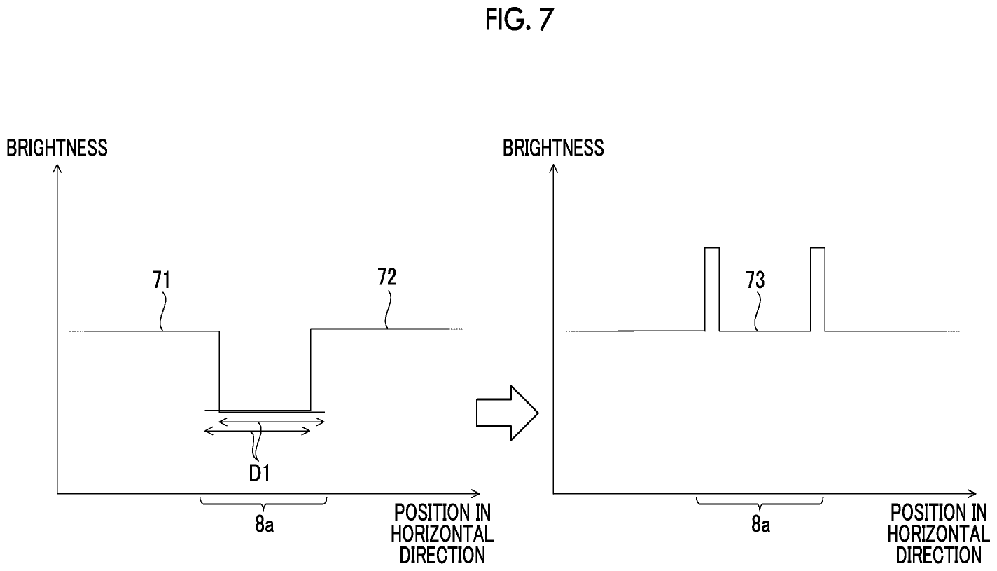

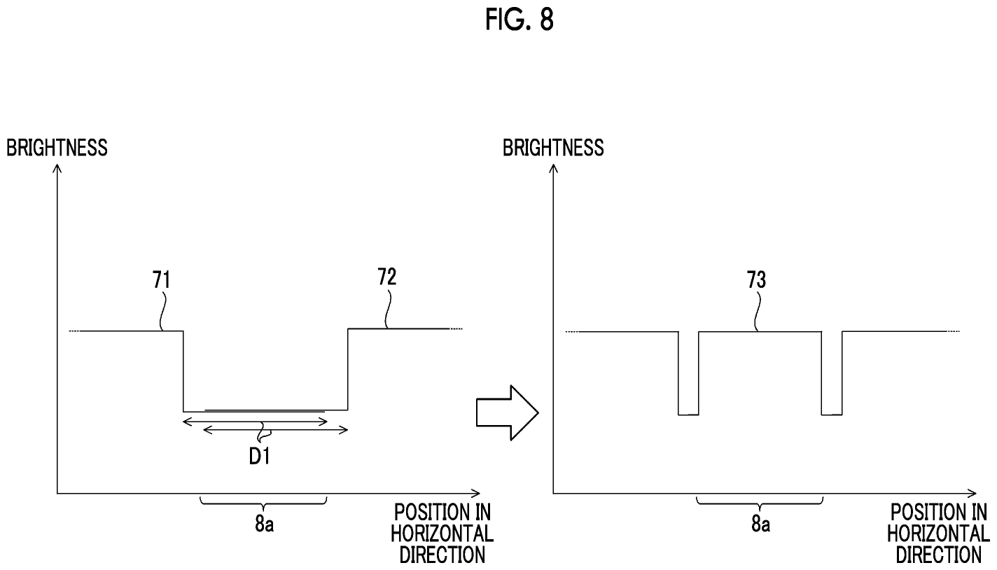

On the other hand, in a case where the overlapping region (overlapping width D) is not correctly set in the projection apparatus 10, the weirdness of the display may be increased. For example, in a case where an overlapping width wider than the actual overlapping width D is set in the projection apparatus 10, the projection apparatus 10 performs the projection control such as decreasing the brightness beyond the actual overlapping region 8a, and the brightness of a part of the display image is unintentionally decreased (for example, refer to FIG. 8). In addition, in a case where an overlapping width narrower than the actual overlapping width D is set in the projection apparatus 10, the projection apparatus 10 does not perform the projection control such as decreasing the brightness on a part of the actual overlapping region 8a, and the brightness of a part of the display image is unintentionally increased (for example, refer to FIG. 7).

Thus, the overlapping region needs to be correctly set in the projection apparatus 10. According to the present invention, a correct overlapping region can be efficiently set in the projection apparatus 10.

<Internal Configuration of First Projection Portion 1a and Second Projection Portion 1b Illustrated in FIG. 1>

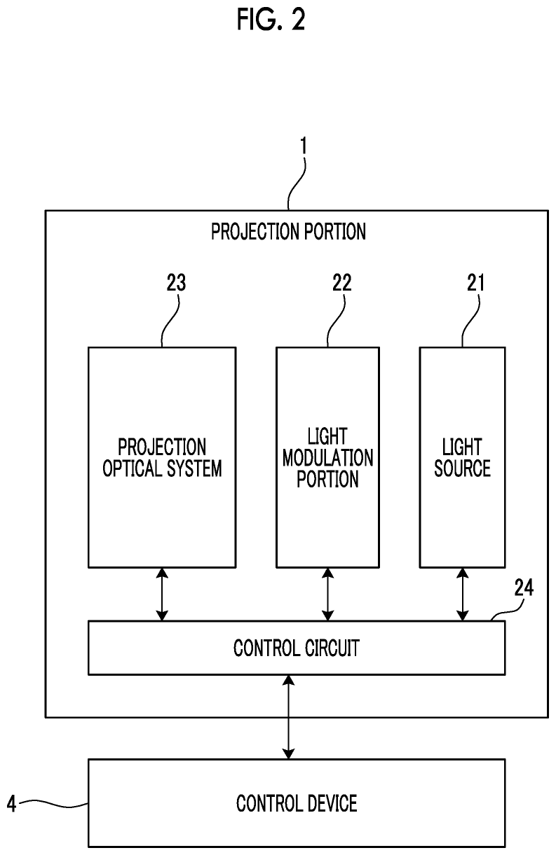

FIG. 2 is a schematic diagram illustrating an example of an internal configuration of the first projection portion 1a and the second projection portion 1b illustrated in FIG. 1.

For example, each of the first projection portion 1a and the second projection portion 1b illustrated in FIG. 1 can be implemented by a projection portion 1 illustrated in FIG. 2. The projection portion 1 comprises a light source 21, a light modulation portion 22, a projection optical system 23, and a control circuit 24.

The light source 21 includes a light emitting element such as a laser or a light emitting diode (LED) and emits, for example, white light.

The light modulation portion 22 is configured with three liquid crystal panels that emit each color image by modulating, based on image information, each color light which is emitted from the light source 21 and is separated into three colors of red, blue, and green by a color separation mechanism, not illustrated. Filters of red, blue, and green may be mounted in each of the three liquid crystal panels, and each color image may be emitted by modulating the white light emitted from the light source 21 in each liquid crystal panel.

The light from the light source 21 and the light modulation portion 22 is incident on the projection optical system 23. The projection optical system 23 includes at least one lens and is configured with, for example, a relay optical system. The light that has passed through the projection optical system 23 is projected to the screen 6.

The control circuit 24 projects an image based on display data to the screen 6 by controlling the light source 21, the light modulation portion 22, and the projection optical system 23 based on the display data input from the control device 4. The display data input into the control circuit 24 is configured with three constituents of red display data, blue display data, and green display data.

In addition, the control circuit 24 enlarges or reduces a projection region of the projection portion 1 by changing the projection optical system 23 based on an instruction input from the control device 4. In addition, the control device 4 may move the projection region of the projection portion 1 by changing the projection optical system 23 based on the operation received by the operation reception portion 2 from the user.

In addition, the projection apparatus 10 comprises a shift mechanism that mechanically or optically moves the projection region while maintaining an image circle of the projection optical system 23. The image circle of the projection optical system 23 is a region in which the projection light incident on the projection optical system 23 appropriately passes through the projection optical system 23 in terms of a light fall-off, color separation, edge part curvature, or the like.

The shift mechanism is implemented by at least any of an optical system shift mechanism that performs optical system shifting, or an electronic shift mechanism that performs electronic shifting.

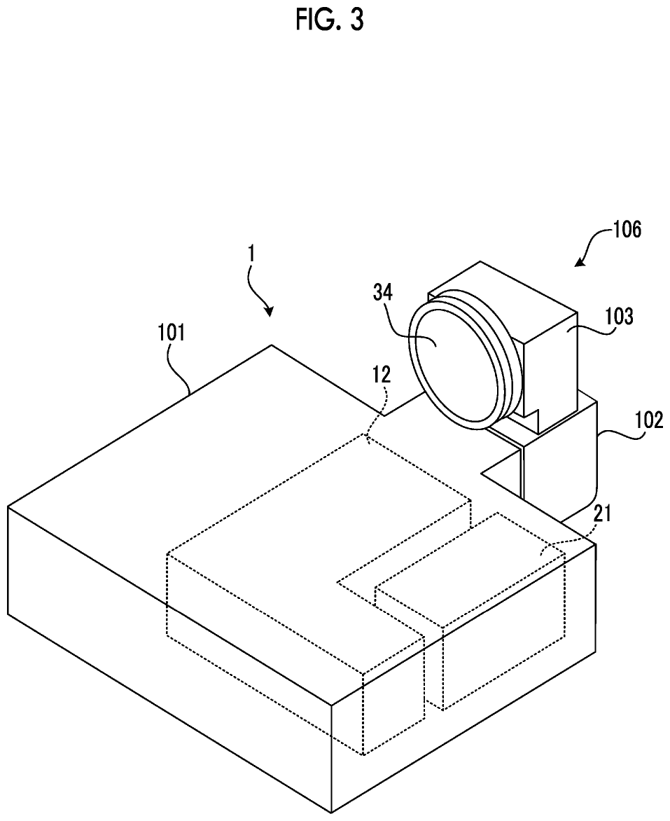

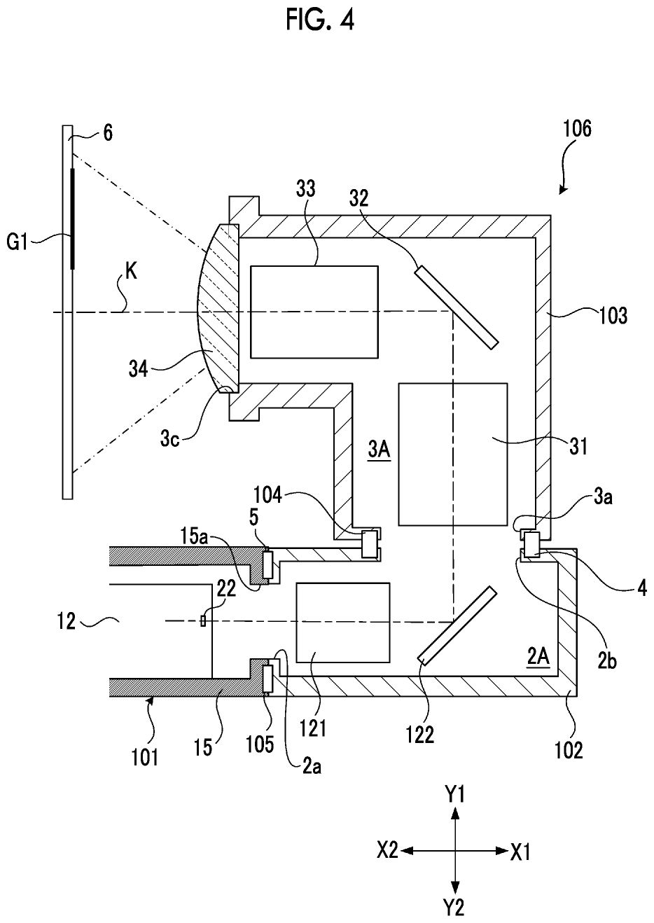

The optical system shift mechanism is, for example, a mechanism (for example, refer to FIG. 3 and FIG. 4) that moves the projection optical system 23 in a direction perpendicular to an optical axis, or a mechanism that moves the light modulation portion 22 in the direction perpendicular to the optical axis instead of moving the projection optical system 23. In addition, the optical system shift mechanism may perform the movement of the projection optical system 23 and the movement of the light modulation portion 22 in combination.

The electronic shift mechanism is a mechanism that performs pseudo shifting of the projection region by changing a range through which the light is transmitted in the light modulation portion 22.

In addition, the projection apparatus 10 may comprise a projection direction changing mechanism that moves the image circle of the projection optical system 23 and the projection region. The projection direction changing mechanism is a mechanism that changes a projection direction of the projection portion 1 by changing a direction of the projection portion 1 by mechanical rotation (for example, refer to FIG. 3 and FIG. 4).

<Mechanical Configuration of Projection Portion 1>

FIG. 3 is a schematic diagram illustrating an exterior configuration of the projection portion 1. FIG. 4 is a schematic cross-sectional view of an optical unit 106 of the projection portion 1 illustrated in FIG. 3. FIG. 4 illustrates a cross section in a plane along an optical path of the light emitted from a body part 101 illustrated in FIG. 3.

As illustrated in FIG. 3, the projection portion 1 comprises the body part 101 and the optical unit 106 that is provided to protrude from the body part 101. In the configuration illustrated in FIG. 3, the light source 21, the light modulation portion 22, and the control circuit 24 in the projection portion 1 are provided in the body part 101. The projection optical system 23 in the projection portion 1 is provided in the optical unit 106.

In a case of implementing each of the first projection portion 1a and the second projection portion 1b by the projection portion 1, the operation reception portion 2, the control device 4, and the imaging portion 5 may be configured as a part of any of the first projection portion 1a and the second projection portion 1b or may be configured as a configuration separated from the first projection portion 1a and the second projection portion 1b.

The optical unit 106 comprises a first member 102 supported by the body part 101 and a second member 103 supported by the first member 102.

The first member 102 and the second member 103 may be an integrated member. The optical unit 106 may be configured to be attachable to and detachable from the body part 101 (in other words, interchangeably configured).

The body part 101 includes a housing 15 (refer to FIG. 4) in which an opening 15a (refer to FIG. 4) for passing light is formed in a part connected to the optical unit 106.

As illustrated in FIG. 3, the light source 21 and a light modulation unit 12 including the light modulation portion 22 (refer to FIG. 2) that generates an image by spatially modulating the light emitted from the light source 21 based on input image data are provided inside the housing 15 of the body part 101.

The light emitted from the light source 21 is incident on the light modulation portion 22 of the light modulation unit 12 and is spatially modulated and emitted by the light modulation portion 22.

As illustrated in FIG. 4, the image formed by the light spatially modulated by the light modulation unit 12 is incident on the optical unit 106 through the opening 15a of the housing 15 and is projected to the screen 6 as a projection target object. Accordingly, an image G1 is visible from an observer.

As illustrated in FIG. 4, the optical unit 106 comprises the first member 102 including a hollow portion 2A connected to the inside of the body part 101, the second member 103 including a hollow portion 3A connected to the hollow portion 2A, a first optical system 121 and a reflective member 122 arranged in the hollow portion 2A, a second optical system 31, a reflective member 32, a third optical system 33, and a lens 34 arranged in the hollow portion 3A, a shift mechanism 105, and a projection direction changing mechanism 104.

The first member 102 is a member having, for example, a rectangular cross-sectional exterior, in which an opening 2a and an opening 2b are formed in surfaces perpendicular to each other. The first member 102 is supported by the body part 101 in a state where the opening 2a is arranged at a position facing the opening 15a of the body part 101. The light emitted from the light modulation portion 22 of the light modulation unit 12 of the body part 101 is incident into the hollow portion 2A of the first member 102 through the opening 15a and the opening 2a.

An incidence direction of the light incident into the hollow portion 2A from the body part 101 will be referred to as a direction X1. A direction opposite to the direction X1 will be referred to as a direction X2. The direction X1 and the direction X2 will be collectively referred to as a direction X. In addition, in FIG. 4, a direction from the front to the back of the page and an opposite direction will be referred to as a direction Z. In the direction Z, the direction from the front to the back of the page will be referred to as a direction Z1, and the direction from the back to the front of the page will be referred to as a direction Z2.

In addition, a direction perpendicular to the direction X and the direction Z will be referred to as a direction Y. In the direction Y, an upward direction in FIG. 4 will be referred to as a direction Y1, and a downward direction in FIG. 4 will be referred to as a direction Y2. In the example in FIG. 4, the projection apparatus 10 is arranged such that the direction Y2 is a vertical direction.

The projection optical system 23 illustrated in FIG. 2 is composed of the first optical system 121, the reflective member 122, the second optical system 31, the reflective member 32, the third optical system 33, and the lens 34. An optical axis K of the projection optical system 23 is illustrated in FIG. 4. The first optical system 121, the reflective member 122, the second optical system 31, the reflective member 32, the third optical system 33, and the lens 34 are arranged in this order from the light modulation portion 22 side along the optical axis K.

The first optical system 121 includes at least one lens and guides the light that is incident on the first member 102 from the body part 101 and travels in the direction X1, to the reflective member 122.

The reflective member 122 reflects the light incident from the first optical system 121 in the direction Y1. The reflective member 122 is configured with, for example, a mirror. In the first member 102, the opening 2b is formed on the optical path of the light reflected by the reflective member 122, and the reflected light travels to the hollow portion 3A of the second member 103 by passing through the opening 2b.

The second member 103 is a member having an approximately T-shaped cross-sectional exterior, in which an opening 3a is formed at a position facing the opening 2b of the first member 102. The light that has passed through the opening 2b of the first member 102 from the body part 101 is incident into the hollow portion 3A of the second member 103 through the opening 3a. The first member 102 and the second member 103 may have any cross-sectional exterior and are not limited to the above.

The second optical system 31 includes at least one lens and guides the light incident from the first member 102 to the reflective member 32.

The reflective member 32 guides the light incident from the second optical system 31 to the third optical system 33 by reflecting the light in the direction X2. The reflective member 32 is configured with, for example, a mirror.

The third optical system 33 includes at least one lens and guides the light reflected by the reflective member 32 to the lens 34.

The lens 34 is arranged in an end part of the second member 103 on the direction X2 side in the form of closing the opening 3c formed in this end part. The lens 34 projects the light incident from the third optical system 33 to the screen 6.

The projection direction changing mechanism 104 is a rotation mechanism that rotatably connects the second member 103 to the first member 102. By the projection direction changing mechanism 104, the second member 103 is configured to be rotatable about a rotation axis (specifically, the optical axis K) that extends in the direction Y. The projection direction changing mechanism 104 is not limited to an arrangement position illustrated in FIG. 4 as long as the projection direction changing mechanism 104 can rotate the optical system. In addition, the number of rotation mechanisms is not limited to one, and a plurality of rotation mechanisms may be provided.

The shift mechanism 105 is a mechanism for moving the optical axis K of the projection optical system (in other words, the optical unit 106) in a direction (direction Y in FIG. 4) perpendicular to the optical axis K. Specifically, the shift mechanism 105 is configured to be capable of changing a position of the first member 102 in the direction Y with respect to the body part 101. The shift mechanism 105 may manually move the first member 102 or electrically move the first member 102.

FIG. 4 illustrates a state where the first member 102 is moved as far as possible to the direction Y1 side by the shift mechanism 105. By moving the first member 102 in the direction Y2 by the shift mechanism 105 from the state illustrated in FIG. 4, a relative position between a center of the image (in other words, a center of a display surface) formed by the light modulation portion 22 and the optical axis K changes, and the image G1 projected to the screen 6 can be shifted (translated) in the direction Y2.

The shift mechanism 105 may be a mechanism that moves the light modulation portion 22 in the direction Y instead of moving the optical unit 106 in the direction Y. Even in this case, the image G1 projected to the screen 6 can be moved in the direction Y2.

<Processing of Receiving Setting of Overlapping Region by Control Device 4>

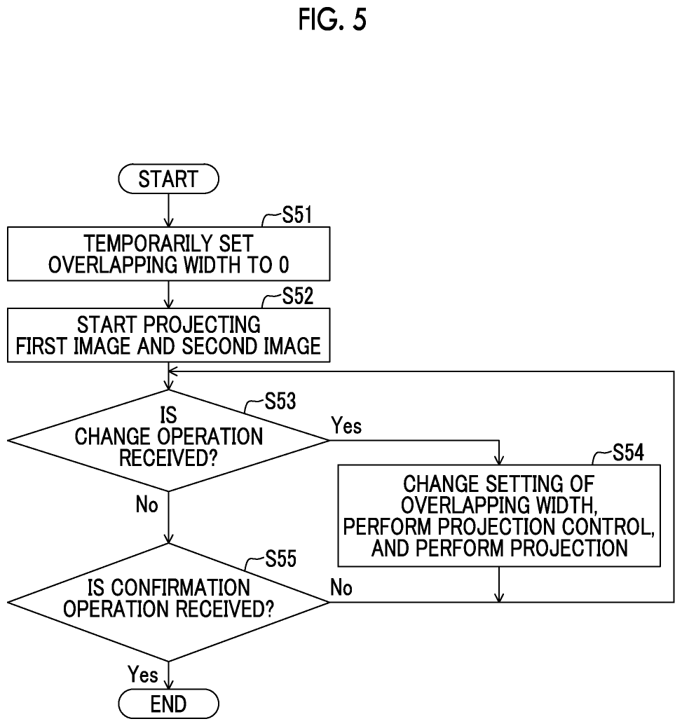

FIG. 5 is a flowchart illustrating an example of processing of receiving a setting of the overlapping region by the control device 4. For example, as illustrated in FIG. 1, in a state where the first projection portion 1a and the second projection portion 1b are arranged such that the first image 7a and the second image 7b partially overlap with each other, the processing illustrated in FIG. 5 is executed in the control device 4.

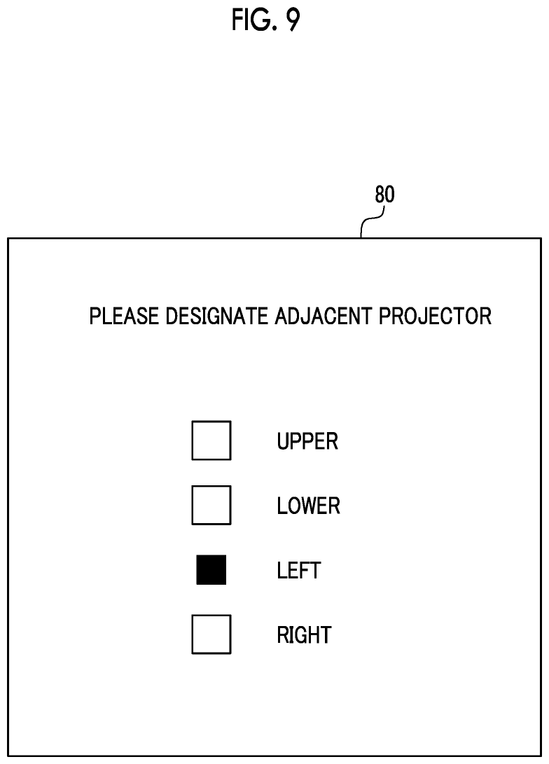

Here, as illustrated in FIG. 1, it is assumed that a positional relationship between the first image 7a and the second image 7b such that the second image 7b is arranged on the right side of the first image 7a toward the screen 6 is set in the projection apparatus 10. A method of setting the positional relationship will be described later (for example, refer to FIG. 9).

First, the control device 4 temporarily sets an overlapping width D1 to 0 (step S51). The overlapping width D1 is an overlapping width set in the control device 4 and, for example, is stored in the storage medium 4a of the control device 4. Next, the control device 4 starts projecting the first image 7a and the second image 7b from the first projection portion 1a and the second projection portion 1b, respectively (step S52). For example, the first image 7a overlaps with the second image 7b as illustrated in FIG. 1. However, in this stage, since the overlapping width D1 is temporarily set to 0 in the control device 4, that is, the first image 7a does not overlap with the second image 7b, the control device 4 does not perform the projection control.

Next, the control device 4 determines whether or not the change operation for changing the overlapping width D1 is received from the user by the operation reception portion 2 (step S53). The change operation constitutes a first operation according to the embodiment of the present invention. In a case where the change operation is received (step S53: Yes), the control device 4 changes the overlapping width D1 in accordance with the received change operation. In addition, the control device 4 performs the projection control on the first image 7a and the second image 7b based on the changed overlapping width D1 and projects the first image 7a and the second image 7b on which the projection control is performed, from the first projection portion 1a and the second projection portion 1b (step S54). The control device 4 returns to step S53.

In step S53, in a case where the change operation is not received (step S53: No), the control device 4 determines whether or not the confirmation operation for confirming the setting (overlapping width D1) of the overlapping region is received from the user by the operation reception portion 2 (step S55).

In step S55, in a case where the confirmation operation is not received (step S55: No), the control device 4 returns to step S53. The confirmation operation constitutes a second operation according to the embodiment of the present invention. In addition, the confirmation operation is an operation indicating that the first region of the first image 7a set as the overlapping region with the second image 7b and the second region of the second image 7b set as the overlapping region with the first image 7a match the overlapping region 8a. In a case where the confirmation operation is received (step S55: Yes), the control device 4 finishes the series of processing.

As described above, in a case where the change operation is received, the control device 4 performs a control of projecting the first image 7a by performing the projection control corresponding to the received change operation and a control of projecting the second image 7b by performing the projection control corresponding to the received change operation. In a case where the confirmation operation for providing an instruction to confirm the overlapping region is received, the control device 4 finishes the controls (steps S53 and S54) corresponding to the change operation.

Accordingly, since the projection is performed by reflecting the result of the change operation by the user on the projection control in real time, the user can perform the change operation while seeing the result of the change operation. Thus, the overlapping region can be efficiently set.

### Specific Example of Projection Control Corresponding to Setting of Overlapping Region

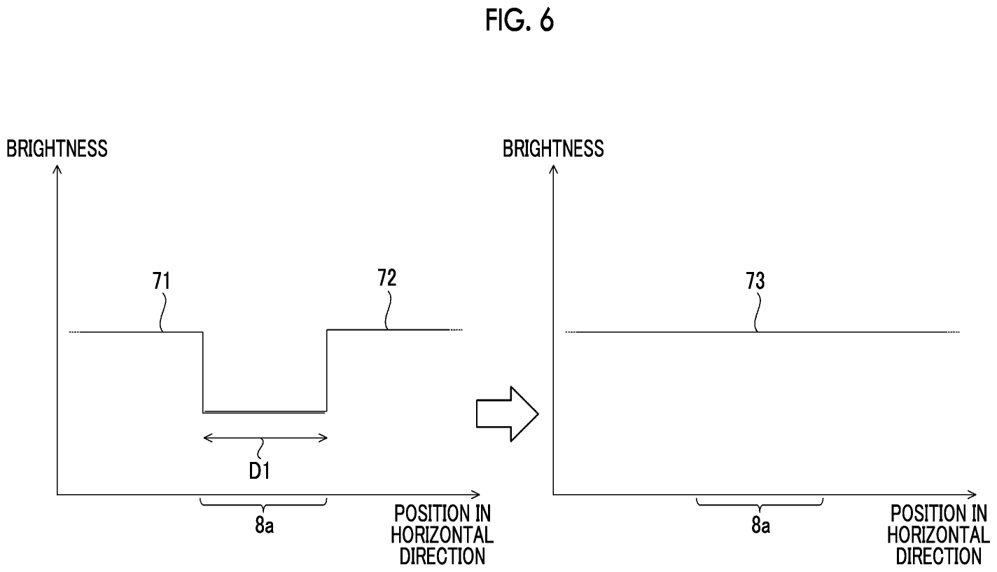

FIG. 6 to FIG. 8 are diagrams illustrating a specific example of the projection control corresponding to the setting of the overlapping region. In each graph of FIG. 6 to FIG. 8, a lateral axis denotes a position in a horizontal direction (lateral direction) on the screen 6, and a vertical axis denotes the brightness of the image.

In addition, here, it is assumed that each of the original first image 7a and second image 7b is an image for adjustment (as an example, an even gray image) having constant brightness at each position, and the control device 4 performs the projection control of decreasing the brightness by half on the overlapping region of each of the first image 7a and the second image 7b.

A brightness distribution 71 is a distribution of the brightness of the first image 7a in the horizontal direction. A brightness distribution 72 is a distribution of the brightness of the second image 7b in the horizontal direction. A brightness distribution 73 is a distribution of the brightness of the image displayed on the screen 6 in the horizontal direction and is a distribution obtained by adding the brightness distribution 71 and the brightness distribution 72 to each other.

The overlapping region 8a is the overlapping region between the first image 7a and the second image 7b as described above, and is a region between a right end of the first image 7a and a left end of the second image 7b. The overlapping width D1 is the width of the overlapping region between the first image 7a and the second image 7b set in the control device 4.

As illustrated in the brightness distribution 71, the control device 4 performs the projection control of decreasing the brightness by half on a region of the first image 7a having the overlapping width D1 from the right end of the first image 7a. In addition, as illustrated in the brightness distribution 72, the control device 4 performs the projection control of decreasing the brightness by half on a region of the second image 7b having the overlapping width D1 from the left end of the second image 7b.

In the example illustrated in FIG. 6, the overlapping width D1 set in the control device 4 matches the actual overlapping width D of the overlapping region 8a. In this case, the projection control of decreasing the brightness by half is performed on only the part of the overlapping region 8a for each of the first image 7a and the second image 7b. Thus, the brightness distribution 73 is constant. Accordingly, the image displayed on the screen 6 is an image (as an example, an even gray image) having constant brightness in the horizontal direction.

In the example illustrated in FIG. 7, the overlapping width D1 set in the control device 4 is narrower than the actual overlapping width D of the overlapping region 8a. In this case, the projection control of decreasing the brightness by half is performed on a part of the overlapping region 8a for only one of the first image 7a and the second image 7b. Thus, a part having higher brightness than the other part occurs in the brightness distribution 73.

Specifically, the brightness in a part inside both ends of the overlapping region 8a in the brightness distribution 73 is increased. Thus, two vertical lines having high brightness occur in the image displayed on the screen 6. Accordingly, the user can recognize that the overlapping width D1 currently set in the control device 4 is narrower than the overlapping width D of the overlapping region 8a, and perform the change operation of increasing the overlapping width D1.

In the example illustrated in FIG. 8, the overlapping width D1 set in the control device 4 is wider than the actual overlapping width D of the overlapping region 8a. In this case, the projection control of decreasing the brightness by half is performed on a range exceeding the overlapping region 8a for both of the first image 7a and the second image 7b. Thus, a part having lower brightness than the other part occurs in the brightness distribution 73.

Specifically, the brightness in parts outside both ends of the overlapping region 8a in the brightness distribution 73 is decreased. Thus, two vertical lines having low brightness occur in the image displayed on the screen 6. Accordingly, the user can recognize that the overlapping width D1 currently set in the control device 4 is wider than the overlapping width D of the overlapping region 8a, and perform the change operation of decreasing the overlapping width D1.

<Setting Screen of Positional Relationship Between First Image 7a and Second Image 7b>

FIG. 9 is a diagram illustrating an example of a setting screen of the positional relationship between the first image 7a and the second image 7b. Here, it is assumed that arrangement of the first projection portion 1a and the second projection portion 1b corresponds to arrangement of the first image 7a and the second image 7b. In this case, the positional relationship between the first image 7a and the second image 7b can be set by setting a positional relationship between the first projection portion 1a and the second projection portion 1b.

For example, the projection apparatus 10 displays a setting screen 80 to the user. The display of the setting screen 80 may be performed by a display provided in the projection apparatus 10 or may be performed by a display provided in another apparatus (for example, a remote controller) that can communicate with the projection apparatus 10. In addition, the display of the setting screen 80 may be performed by including the setting screen 80 in at least any of the first image 7a or the second image 7b.

In the example illustrated in FIG. 9, it is assumed that a projection portion as a reference out of the first projection portion 1a and the second projection portion 1b is set in the control device 4. The projection portion as the reference may be set by the control device 4 based on an identification number or the like unique to each projection portion or may be set by the user through the operation reception portion 2. Here, it is assumed that the second projection portion 1b is set in the control device 4 as the projection portion as the reference.

For example, the setting screen 80 is a screen on which a designation of a position (any of upper, lower, left, and right) of a projector (first projection portion 1a) adjacent to the second projection portion 1b based on the second projection portion 1b is received from the user. The user designates a position of the first projection portion 1a adjacent to the second projection portion 1b on the setting screen 80 through the operation reception portion 2.

In the example illustrated in FIG. 1, since the first projection portion 1a is positioned on the left of the second projection portion 1b toward the screen 6, the user designates left as the position of the first projection portion 1a based on the second projection portion 1b as illustrated in FIG. 9. Accordingly, the positional relationship between the first projection portion 1a and the second projection portion 1b (that is, the positional relationship between the first image 7a and the second image 7b) can be set in the projection apparatus 10.

By setting the positional relationship between the first projection portion 1a and the second projection portion 1b in the projection apparatus 10, the projection apparatus 10 can determine which end part is the overlapping region 8a for each of the first image 7a and the second image 7b. Thus, by further setting the overlapping width D1 in the projection apparatus 10, the projection apparatus 10 can set a region of the overlapping region 8a in each of the first image 7a and the second image 7b. Accordingly, the change operation for changing the setting of the overlapping region by the user can be simplified to the operation for increasing or decreasing the overlapping width D1.

As described above, the projection apparatus 10 sets a region (the first region and the second region) as the overlapping region for each of the first image 7a and the second image 7b based on the positional relationship between the first projection portion 1a and the second projection portion 1b. Accordingly, the change operation for changing the setting of the overlapping region can be simplified, and the overlapping region can be more efficiently set.

For example, the setting of the positional relationship between the first projection portion 1a and the second projection portion 1b (the first image 7a and the second image 7b) in the projection apparatus 10 can be performed based on the user instruction as in the example illustrated in FIG. 9. However, the setting of the positional relationship between the first projection portion 1a and the second projection portion 1b is not limited to the user instruction and, for example, may be performed based on the captured image obtained by imaging of the imaging portion 5 illustrated in FIG. 1.

<User Interface for Receiving Change Operation and Confirmation Operation from User>

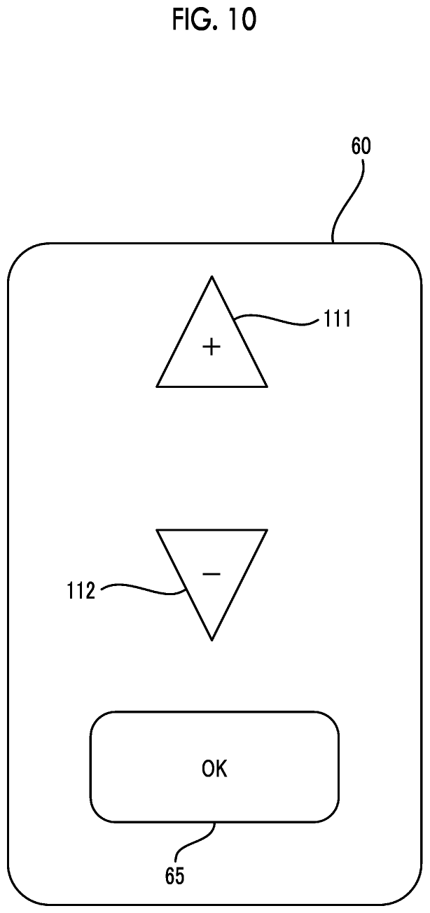

FIG. 10 is a diagram illustrating an example of a user interface for receiving the change operation and the confirmation operation from the user.

For example, the operation reception portion 2 can be used as a reception portion that receives a signal from a remote controller 60 illustrated in FIG. 10. The remote controller 60 includes an increase key 111, a decrease key 112, and an OK key 65. The increase key 111 is a key for instructing the control device 4 to increase the overlapping width D1. The decrease key 112 is a key for instructing the control device 4 to decrease the overlapping width D1. The increase key 111 is designated by a symbol “+”, and the decrease key 112 is designated by a symbol “−”.

As an example, the change operation for changing the setting (overlapping width D1) of the overlapping region can be a push on the increase key 111 or the decrease key 112. For example, the control device 4 increases the setting of the overlapping width D1 by a predetermined amount in a case where the increase key 111 is pushed once, and decreases the setting of the overlapping width D1 by a predetermined amount in a case where the decrease key 112 is pushed once. Alternatively, the control device 4 may increase the setting of the overlapping width D1 in accordance with a time period in which the increase key 111 is pushed, and decrease the setting of the overlapping width D1 in accordance with a length of a time period in which the decrease key 112 is pushed.

In a case where the setting of the overlapping width D1 is changed in accordance with the push on the increase key 111 or the decrease key 112, the control device 4 immediately (that is, without waiting for a push on the OK key 65) performs the projection control and the projection based on the setting of the overlapping width D1 after change.

For example, the confirmation operation for confirming the setting (overlapping width D1) of the overlapping region can be the push on the OK key 65. For example, in a case where the OK key 65 is pushed, the projection apparatus 10 finishes a control of performing the projection control and the projection in accordance with the change operation.

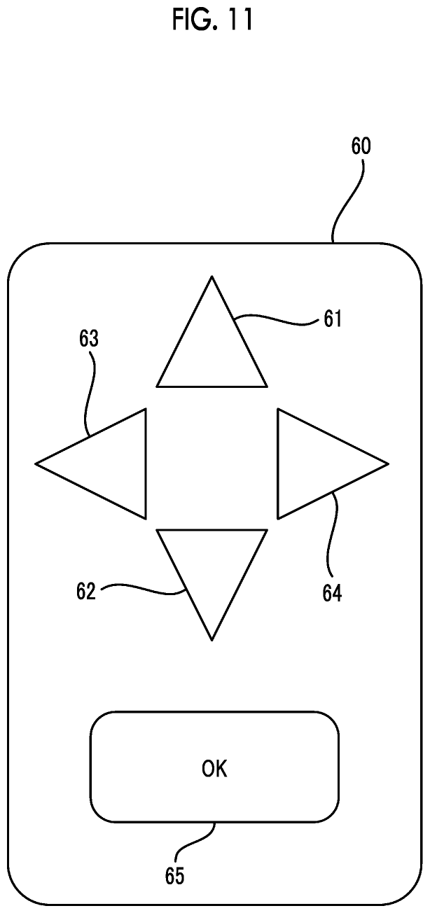

FIG. 11 is a diagram illustrating another example of the user interface for receiving the change operation and the confirmation operation from the user.

The remote controller 60 may include direction keys 61 to 64 and the OK key 65. The direction keys 61 to 64 are keys for providing instructions for upper, lower, left, and right to the control device 4, respectively. The change operation for changing the setting (overlapping width D1) of the overlapping region may be a push on the direction keys 61 to 64.

In the example illustrated in FIG. 11, it is assumed that the projection portion as the reference out of the first projection portion 1a and the second projection portion 1b is set in the control device 4. The projection portion as the reference may be set by the control device 4 based on the identification number or the like unique to each projection portion or may be set by the user through the operation reception portion 2. Here, it is assumed that the first projection portion 1a is set in the control device 4 as the projection portion as the reference.

On the other hand, it is assumed that the positional relationship between the first projection portion 1a and the second projection portion 1b (the first image 7a and the second image 7b) is not set yet in the control device 4. In this case, the control device 4 may detect the positional relationship between the first projection portion 1a and the second projection portion 1b in accordance with the change operation that is received for the first time after the first image 7a and the second image 7b are projected.

For example, as in the example illustrated in FIG. 5, in a case where the overlapping width D1 is set to 0 at a point in time when the projection of the first image 7a and the second image 7b is started, a state where the brightness of the entire overlapping region 8a is higher than the original brightness of the first image 7a and the second image 7b is set. In this state, it is considered that the user performs an operation of increasing the overlapping region 8a in order to narrow a region having high brightness.

From this point, for example, in a case where the user provides the instruction for left by the direction key 63, it can be predicted that the overlapping region 8a is positioned on a right side in the first image 7a of the first projection portion 1a as the reference, and the second projection portion 1b is positioned on a right side of the first projection portion 1a as in the example in FIG. 1.

Accordingly, in a case where the push on the direction key 63 is received for the first time, the control device 4 determines that the second projection portion 1b is positioned on the right side of the first projection portion 1a, and sets the determined positional relationship and increases the overlapping width D1 in accordance with the received push on the direction key 63. Then, the control device 4 further increases the overlapping width D1 in a case where the push on the direction key 63 is received, and decreases the overlapping width D1 in a case where the push on the direction key 64 is received.

As another case, for example, in a case where the user pushes the direction key 64 for the first time, the control device 4 determines that the second projection portion 1b is positioned on a left side of the first projection portion 1a. In addition, in a case where the user pushes the direction key 61 for the first time, the control device 4 determines that the second projection portion 1b is positioned on a lower side of the first projection portion 1a. In addition, in a case where the user pushes the direction key 62 for the first time, the control device 4 determines that the second projection portion 1b is positioned on an upper side of the first projection portion 1a.

As described above, the control device 4 may detect the positional relationship between the first projection portion 1a and the second projection portion 1b in accordance with the change operation that is received for the first time after the first image 7a and the second image 7b are projected. Accordingly, for example, even in a case where the user does not set the positional relationship between the first projection portion 1a and the second projection portion 1b by the setting screen 80 illustrated in FIG. 9, the control device 4 can automatically set the positional relationship between the first projection portion 1a and the second projection portion 1b.

<Guide Information for Providing Guide for Method of Change Operation>

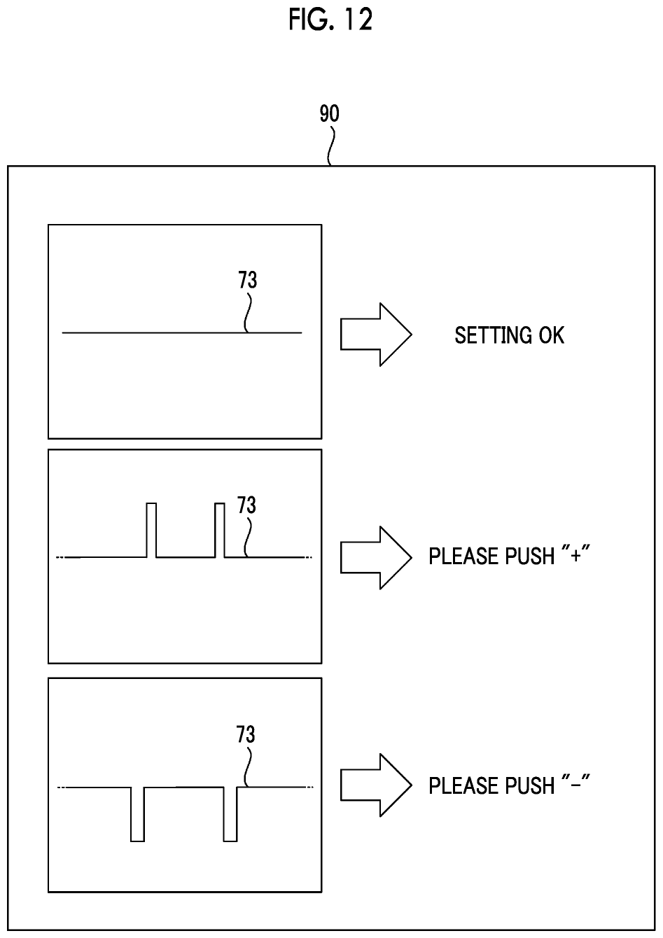

FIG. 12 is a diagram illustrating an example of guide information for providing a guide for a method of the change operation. For example, in a state where the change operation is received, for example, the control device 4 may perform a control of displaying guide information 90.

For example, the guide information 90 can be displayed on the screen 6 by including the guide information 90 in at least any of the first image 7a or the second image 7b. However, the display of the guide information 90 is not limited thereto and, for example, may be performed by the display comprised in the projection apparatus 10 or may be performed by the display provided in the other apparatus that can communicate with the projection apparatus 10.

A case of performing processing of decreasing the brightness as the projection control as in the examples illustrated in FIG. 6 to FIG. 8 and using the remote controller 60 illustrated in FIG. 10 as the user interface for the user to perform the change operation will be described using FIG. 12.

The guide information 90 is information for providing the guide for the method of the change operation for each state of the projected first image 7a and second image 7b. In the example illustrated in FIG. 12, the guide information 90 illustrates the brightness distribution 73 illustrating the states of the projected first image 7a and second image 7b and the change operation to be performed by the user for each state of the overlapping width D1 illustrated in FIG. 6 to FIG. 8 and set in the control device 4.

For example, in the guide information 90, a character string “setting OK” is displayed in association with the brightness distribution 73 illustrated in FIG. 6. Accordingly, the user can easily recognize that a further change operation does not need to be performed in a case where the first image 7a and the second image 7b displayed on the screen 6 are in the state illustrated by the brightness distribution 73 illustrated in FIG. 6 (a state where two vertical lines having different brightness are not seen).

In addition, in the guide information 90, a character string “please push “+”” is displayed in association with the brightness distribution 73 illustrated in FIG. 7. Accordingly, the user can easily recognize that the increase key 111 may be pushed in a case where the first image 7a and the second image 7b displayed on the screen 6 are in the state illustrated by the brightness distribution 73 illustrated in FIG. 7 (a state where two bright vertical lines are seen).

In addition, in the guide information 90, a character string “please push “−”” is displayed in association with the brightness distribution 73 illustrated in FIG. 8. Accordingly, the user can easily recognize that the decrease key 112 may be pushed in a case where the first image 7a and the second image 7b displayed on the screen 6 are in the state illustrated by the brightness distribution 73 illustrated in FIG. 8 (a state where two dark vertical lines are seen).

That is, the user may repeat the change operation of pushing the increase key 111 in a case where two bright vertical lines are seen and pushing the decrease key 112 in a case where two dark vertical lines are seen, and push the OK key 65 as the confirmation operation after the two vertical lines having different brightness are not seen anymore.

<Projection Apparatus 10 Including Three or More Projection Portions>

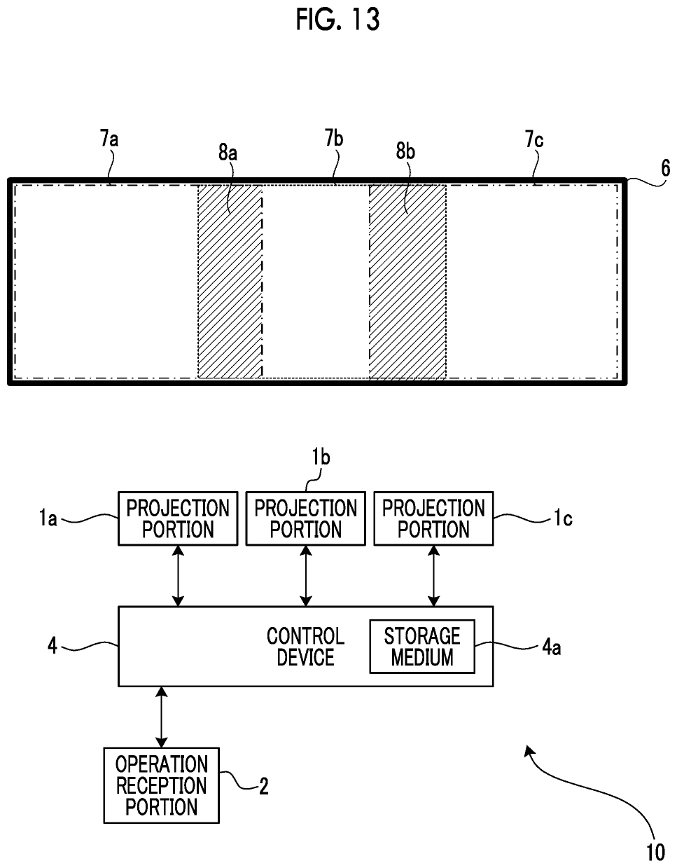

FIG. 13 is a diagram illustrating an example of the projection apparatus 10 including three or more projection portions. In the example illustrated in FIG. 13, the projection apparatus 10 comprises a third projection portion 1c in addition to the first projection portion 1a and the second projection portion 1b illustrated in FIG. 1. For example, the third projection portion 1c can be implemented by the projection portion 1 illustrated in FIG. 2 like the first projection portion 1a and the second projection portion 1b.

A third image 7c illustrated by a double dot dashed line is an image projected to the screen 6 by the third projection portion 1c. The third image 7c is rectangular like the first image 7a and the second image 7b.

In addition, the projection apparatus 10 projects the second image 7b and the third image 7c in a partially overlapping manner. In the example illustrated in FIG. 13, an overlapping region 8b illustrated by diagonal lines is a region in which the second image 7b overlaps with the third image 7c.

As described above, in a case where the projection apparatus 10 includes three or more projection portions, the overlapping region needs to be set for each combination of projection portions of which projection images overlap. In order to do so, a combination of projection portions of a current setting target needs to be designated in the projection apparatus 10.

<Processing of Receiving Setting of Overlapping Region by Projection Apparatus 10 Including Three Projection Portions>

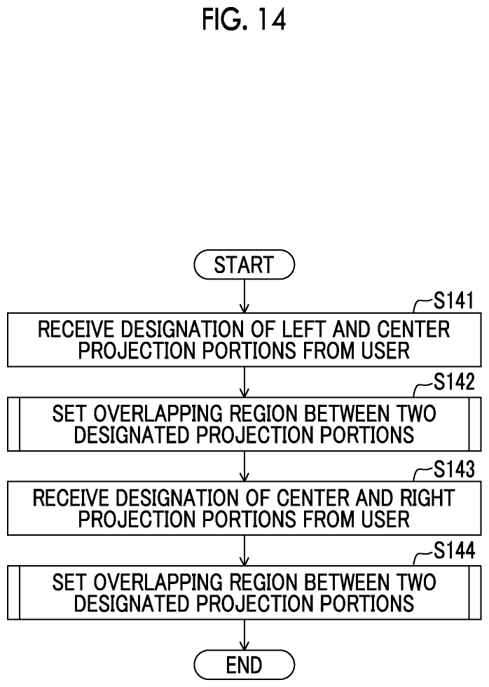

FIG. 14 is a flowchart illustrating an example of processing of receiving a setting of an overlapping region by the projection apparatus 10 including three projection portions.

For example, as illustrated in FIG. 13, in a state where the first projection portion 1a, the second projection portion 1b, and the third projection portion 1c are arranged such that the first image 7a, the second image 7b, and the third image 7c are laterally arranged in a row, the first image 7a and the second image 7b partially overlap with each other, and the second image 7b and the third image 7c partially overlap with each other, the processing illustrated in FIG. 14 is executed in the control device 4.

Here, it is assumed that a configuration in which three projection portions are laterally arranged in a row is set in the projection apparatus 10. For example, this setting is set in advance in the projection apparatus 10 by the user through the operation reception portion 2. On the other hand, it is assumed that a positional relationship as to at which of left, center, and right positions each of the first projection portion 1a, the second projection portion 1b, and the third projection portion 1c is arranged is not set in the projection apparatus 10.

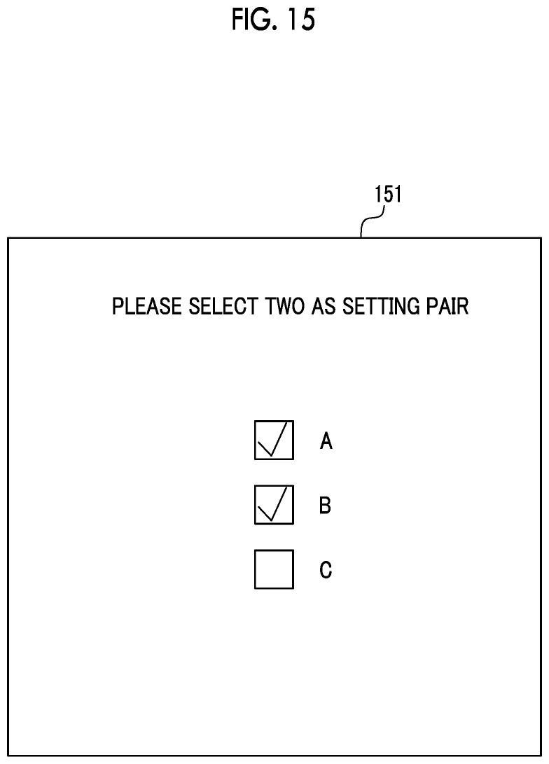

First, the control device 4 receives a designation of left and center projection portions among the three projection portions as combination information from the user through the operation reception portion 2 (step S141). In the example illustrated in FIG. 13, the user designates the first projection portion 1a as the left projection portion and designates the second projection portion 1b as the center projection portion in step S141. A method of performing this designation will be described later (for example, refer to FIG. 15).

Next, the control device 4 sets an overlapping region between the two projection portions designated in step S141 (step S142). For example, the setting of the overlapping region in step S142 is performed using the same processing as the processing illustrated in FIG. 5.

Next, the control device 4 receives a designation of center and right projection portions among the three projection portions as the combination information from the user through the operation reception portion 2 (step S143). In the example illustrated in FIG. 13, the user designates the second projection portion 1b as the center projection portion and designates the third projection portion 1c as the right projection portion in step S143. A method of performing this designation will be described later (for example, refer to FIG. 15). In step S143, since the center projection portion is already designated in step S141, the control device 4 may receive the designation of only the right projection portion.

Next, the control device 4 sets an overlapping region between the two projection portions designated in step S143 (step S144) and finishes the series of processing. For example, the setting of the overlapping region in step S144 is performed using the same processing as the processing illustrated in FIG. 5.

In steps S141 and S143, the control device 4 may receive a designation of only a combination of two projection portions for setting the overlapping region from the user without distinguishing the left, center, and right positions. In this case, the control device 4 may set the positional relationship between the two designated projection portions by the user operation using the setting screen 80 or the like illustrated in FIG. 9, or automatically using the method described using FIG. 11.

As described above, the control device 4 receives the combination information indicating partial overlapping of respective images of two projection portions among projection images of three of the first projection portion 1a, the second projection portion 1b, and the third projection portion 1c from the user and performs the control corresponding to the change operation for the two projection portions based on the received combination information. Accordingly, even in the projection apparatus 10 including three of the first projection portion 1a, the second projection portion 1b, and the third projection portion 1c, the overlapping region can be set for each combination of the projection portions of which the projection images overlap.

<Setting Screen on which Projection Apparatus 10 Receives Designation of Combination of Projection Portions of Setting Target>

FIG. 15 is a diagram illustrating an example of a setting screen on which the projection apparatus 10 receives the designation of the combination of the projection portions of the setting target. Here, it is assumed that the first projection portion 1a, the second projection portion 1b, and the third projection portion 1c are designated by identifiers “A”, “B”, and “C”, respectively, that are identifiable by the user.

For example, the projection apparatus 10 displays a setting screen 151 to the user. The display of the setting screen 151 may be performed by the display provided in the projection apparatus 10 or may be performed by the display provided in the other apparatus that can communicate with the projection apparatus 10. In addition, the display of the setting screen 151 may be performed by including the setting screen 151 in at least any of the first image 7a, the second image 7b, or the third image 7c.

On the setting screen 151, for example, two projection portions can be selected from the first projection portion 1a, the second projection portion 1b, and the third projection portion 1c (“A”, “B”, and “C”) by the user operation through the operation reception portion 2. Specifically, “A”, “B”, and “C” are displayed as options on the setting screen 151 together with a character string “please select two as setting pair”. The user can designate two among “A”, “B”, and “C” through the operation reception portion 2.

For example, in step S141 illustrated in FIG. 14, as illustrated in FIG. 15, the user designates the first projection portion 1a and the second projection portion 1b (“A” and “B”) as the left and center projection portions using the setting screen 151. In addition, in step S143 illustrated in FIG. 14, the user designates the second projection portion 1b and the third projection portion 1c (“B” and “C”) as the center and right projection portions using the setting screen 151.

<Processing of Receiving Setting of Overlapping Region by Projection Apparatus 10 Including N Projection Portions>

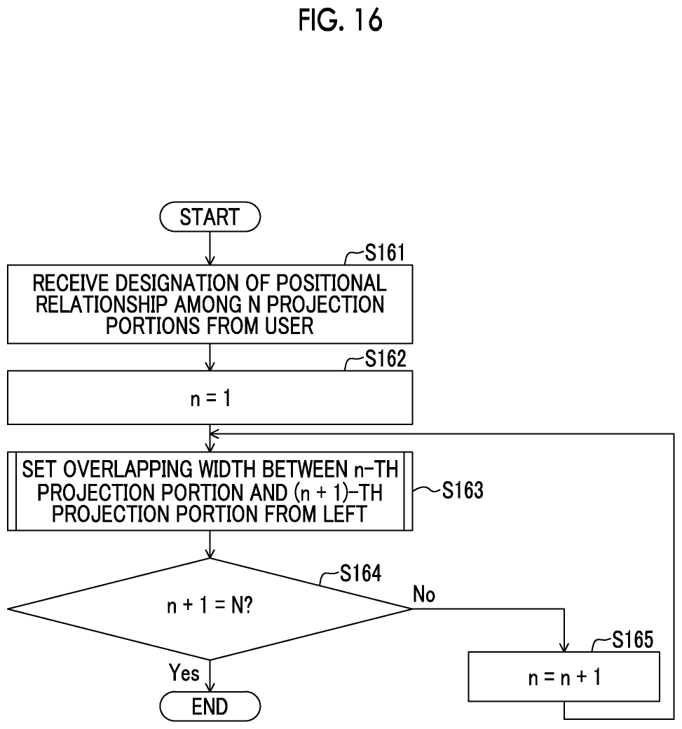

FIG. 16 is a flowchart illustrating an example of processing of receiving a setting of an overlapping region by the projection apparatus 10 including N projection portions.

In the example illustrated in FIG. 16, it is assumed that the projection apparatus 10 comprises N (N is a natural number greater than or equal to 3) projection portions, the N projection portions are laterally arranged in a row, and projection images partially overlap with each other between adjacent projection portions. In this state, the processing illustrated in FIG. 16 is executed in the control device 4.

First, the control device 4 receives a designation of a positional relationship between the N projection portions (each projection image) from the user through the operation reception portion 2 (step S161). For example, in the example illustrated in FIG. 13, the user designates a positional relationship such that the first projection portion 1a, the second projection portion 1b, and the third projection portion 1c are arranged in this order from left in step S161.

Next, the control device 4 sets (initializes) n to 1 (step S162). Here, n is a numerical value stored in the storage medium 4a by the control device 4.

Next, the control device 4 sets the overlapping width D between the n-th projection portion and the (n+1)-th projection portion from left based on current n (step S163) and finishes the series of processing. For example, the setting of the overlapping width in step S163 is performed using the processing illustrated in FIG. 5.

Next, the control device 4 determines whether or not n+1 reaches N based on current n (step S164). In a case where n+1 does not reach N (step S164: No), the control device 4 increments n (n=n+1) (step S165) and returns to step S163. In a case where n+1 reaches N (step S164: Yes), the control device 4 finishes the series of processing.

As described above, by setting the overlapping region for each combination of projection portions adjacent to each other among three or more projection portions based on the positional relationship of respective images projected by the three or more projection portions, the control device 4 can control a region on which the projection control for the overlapping region is performed.

At this point, as illustrated in FIG. 16, by setting an order of combinations of projection portions for setting the overlapping region in the projection apparatus 10, the overlapping region can be more efficiently set.

In step S163 illustrated in FIG. 16, the control device 4 may perform a control of displaying (for example, highlighted display) each projection image of the n-th projection portion and the (n+1)-th projection portion in a distinguishable manner from projection images of the other projection portions. Accordingly, the user can easily perceive the combination of the projection portions as the setting target and can more efficiently set the overlapping region.

### Modification Example

For example, in the processing illustrated in FIG. 5, while processing of temporarily setting the overlapping width D1 to 0 as an initial state is described, an initial value of the overlapping width D1 is not limited to 0. For example, in step S51 illustrated in FIG. 5, the control device 4 may set the overlapping width D1 to the same value as a lateral width of the first image 7a or the second image 7b.

In addition, for example, in the examples illustrated in FIG. 6 to FIG. 8, while a configuration of performing the projection control of decreasing the brightness on the overlapping region 8a for the first image 7a and the second image 7b each having constant brightness is described, the projection control is not limited to such a configuration.

For example, the projection control in which a color of the overlapping region 8a of the first image 7a is set to a first color, and a color of the overlapping region 8a of the second image 7b is set to a second color that is a complementary color to the first color may be performed using the first image 7a and the second image 7b each of which is white and has constant brightness. As an example, the first color can be set to blue, and the second color can be set to orange.

In this case, in a case where the overlapping width D1 set in the control device 4 matches the overlapping width D of the overlapping region 8a, the image displayed on the screen 6 is a constant white image in the horizontal direction. On the other hand, in a case where the overlapping width D1 set in the control device 4 does not match the overlapping width D of the overlapping region 8a, a part of blue or orange occurs in the image displayed on the screen 6. Accordingly, the user can easily recognize a difference between the overlapping width D1 set in the control device 4 and the overlapping width D of the overlapping region 8a.

While a configuration in which the operation reception portion 2 is the reception portion that receives the signal from the remote controller 60 illustrated in FIG. 10 and FIG. 11 is described, the operation reception portion 2 may be a reception portion that receives a signal from an information terminal such as a smartphone, or may be a user interface such as a button or a touch panel provided in the projection apparatus 10.

While a configuration in which the control device 4 performs the projection control on all of respective images (the first image 7a and the second image 7b) overlapping with each other is described, a configuration in which the control device 4 performs the projection control on only one of respective images overlapping with each other may be used. For example, the control device 4 may perform the projection control of setting the brightness of the region of the first image 7a set as the overlapping region 8a to 0 and not perform the projection control of decreasing the brightness on the second image 7b.

At least the following matters are disclosed in the present specification.

(1) A projection apparatus that projects a first image projected by a first projection portion and a second image projected by a second projection portion in a partially overlapping manner, the projection apparatus comprising a processor configured to perform a projection control on a first region of the first image set as an overlapping region with the second image and a second region of the second image set as an overlapping region with the first image, in which the processor is configured to, in a case where a first operation of providing an instruction to change the first region and the second region is received, perform at least any of a control of projecting the first image from the first projection portion by performing the projection control corresponding to the received first operation on the first region or a control of projecting the second image from the second projection portion by performing the projection control corresponding to the received first operation on the second region, and in a case where a second operation of providing an instruction to confirm the first region is received, finish the control corresponding to the first operation.

(2) The projection apparatus according to (1), in which the projection control includes processing of decreasing brightness.

(3) The projection apparatus according to (1) or (2), in which the processor is configured to perform a first projection control on the first region and perform a second projection control on the second region, in a case where the first operation of providing the instruction to change the first region and the second region is received, perform the control of projecting the first image in which the first projection control is performed on the first region changed in accordance with the received first operation, from the first projection portion and projecting the second image in which the second projection control is performed on the second region changed in accordance with the received first operation, from the second projection portion, and in a case where the second operation of providing an instruction to confirm the first region and the second region is received, finish the control corresponding to the first operation.

(4) The projection apparatus according to (3), in which the first projection control includes processing of setting a color of the first region to a first color, and the second projection control includes processing of setting a color of the second region to a second color that is a complementary color to the first color.

(5) The projection apparatus according to any one of (1) to (4), in which the processor is configured to set the first region of the first image based on a positional relationship between a projection region of the first image and a projection region of the second image.

(6) The projection apparatus according to (5), in which the processor is configured to set the positional relationship between the projection region of the first image and the projection region of the second image based on a user instruction.

(7) The projection apparatus according to (5), in which the processor is configured to set the positional relationship between the projection region of the first image and the projection region of the second image based on imaging data of an imaging apparatus.

(8) The projection apparatus according to (5), in which the processor is configured to detect the positional relationship in accordance with the first operation that is received for a first time after the first image and the second image are projected.

(9) The projection apparatus according to any one of (1) to (8), in which the processor is configured to perform a control of displaying guide information for providing a guide for a method of the first operation for each state of the projected first image and second image.

(10) The projection apparatus according to (9), in which the processor is configured to perform a control of displaying the guide information by including the guide information in at least any of the first image or the second image.

(11) The projection apparatus according to any one of (1) to (10), in which the processor is configured to receive combination information indicating partial overlapping between respective images projected by the first projection portion and the second projection portion among three or more projection portions including the first projection portion and the second projection portion, and perform the control corresponding to the first operation for the first projection portion and the second projection portion based on the received combination information.

(12) The projection apparatus according to any one of (1) to (11), in which the processor is configured to control a region on which a projection control for the overlapping region is performed, for each combination of projection portions adjacent to each other among three or more projection portions including the first projection portion and the second projection portion based on a positional relationship of respective images projected by the three or more projection portions.

(13) The projection apparatus according to any one of (1) to (12), in which the second operation is an operation indicating that the first region matches the overlapping region between the first image and the second image.

(14) A projection method by a projection apparatus that projects a first image projected by a first projection portion and a second image projected by a second projection portion in a partially overlapping manner, the projection method comprising, by a processor of the projection apparatus configured to perform a projection control on a first region of the first image set as an overlapping region with the second image and a second region of the second image set as an overlapping region with the first image, performing, in a case where a first operation of providing an instruction to change the first region and the second region is received, at least any of a control of projecting the first image from the first projection portion by performing the projection control corresponding to the received first operation on the first region or a control of projecting the second image from the second projection portion by performing the projection control corresponding to the received first operation on the second region, and finishing, in a case where a second operation of providing an instruction to confirm the first region is received, the control corresponding to the first operation.

(15) The projection method according to (14), in which the projection control includes processing of decreasing brightness.

(16) The projection method according to (14) or (15), in which the processor is configured to perform a first projection control on the first region and perform a second projection control on the second region, in a case where the first operation of providing the instruction to change the first region and the second region is received, perform the control of projecting the first image in which the first projection control is performed on the first region changed in accordance with the received first operation, from the first projection portion and projecting the second image in which the second projection control is performed on the second region changed in accordance with the received first operation, from the second projection portion, and in a case where the second operation of providing an instruction to confirm the first region and the second region is received, finish the control corresponding to the first operation.

(17) The projection method according to (16), in which the first projection control includes processing of setting a color of the first region to a first color, and the second projection control includes processing of setting a color of the second region to a second color that is a complementary color to the first color.

(18) The projection method according to any one of (14) to (17), in which the processor is configured to set the first region of the first image based on a positional relationship between a projection region of the first image and a projection region of the second image.

(19) The projection method according to (18), in which the processor is configured to set the positional relationship between the projection region of the first image and the projection region of the second image based on a user instruction.

(20) The projection method according to (18), in which the processor is configured to set the positional relationship between the projection region of the first image and the projection region of the second image based on imaging data of an imaging apparatus.

(21) The projection method according to (18), in which the processor is configured to detect the positional relationship in accordance with the first operation that is received for a first time after the first image and the second image are projected.

(22) The projection method according to any one of (14) to (21), in which the processor is configured to perform a control of displaying guide information for providing a guide for a method of the first operation for each state of the projected first image and second image.

(23) The projection method according to (22), in which the processor is configured to perform a control of displaying the guide information by including the guide information in at least any of the first image or the second image.

(24) The projection method according to any one of (14) to (23), in which the processor is configured to receive combination information indicating partial overlapping between respective images projected by the first projection portion and the second projection portion among three or more projection portions including the first projection portion and the second projection portion, and perform the control corresponding to the first operation for the first projection portion and the second projection portion based on the received combination information.

(25) The projection method according to any one of (14) to (24), in which the processor is configured to control a region on which a projection control for the overlapping region is performed, for each combination of projection portions adjacent to each other among three or more projection portions including the first projection portion and the second projection portion based on a positional relationship of respective images projected by the three or more projection portions.

(26) The projection method according to any one of (14) to (25), in which the second operation is an operation indicating that the first region matches the overlapping region between the first image and the second image.

(27) A control program of a projection apparatus that projects a first image projected by a first projection portion and a second image projected by a second projection portion in a partially overlapping manner, the control program causing a processor of the projection apparatus to execute a process, the processor being configured to perform a projection control on a first region of the first image set as an overlapping region with the second image and a second region of the second image set as an overlapping region with the first image, the process comprising performing, in a case where a first operation of providing an instruction to change the first region and the second region is received, at least any of a control of projecting the first image from the first projection portion by performing the projection control corresponding to the received first operation on the first region or a control of projecting the second image from the second projection portion by performing the projection control corresponding to the received first operation on the second region, and finishing, in a case where a second operation of providing an instruction to confirm the first region is received, the control corresponding to the first operation.

While various embodiments are described above with reference to the drawings, the present invention is not limited to such examples. It is apparent that those skilled in the art may perceive various modification examples or correction examples within the scope disclosed in the claims, and those examples are also understood as falling in the technical scope of the present invention. In addition, any combination of various constituents in the embodiment may be used without departing from the gist of the invention.

The present application is based on Japanese Patent Application (JP2020-030816) filed on Feb. 26, 2020, the content of which is incorporated in the present application by reference.

### EXPLANATION OF REFERENCES

1: projection portion
1a: first projection portion
1b: second projection portion
1c: third projection portion
2: operation reception portion
2A, 3A: hollow portion
2a, 2b, 3a, 3c, 15a: opening
4: control device
4a: storage medium
5: imaging portion
6: screen
7a: first image
7b: second image
7c: third image
8a, 8b: overlapping region
10: projection apparatus
12: light modulation unit
15: housing
21: light source
22: light modulation portion
23: projection optical system
24: control circuit
31: second optical system
32, 122: reflective member
33: third optical system
34: lens
60: remote controller
61 to 64: direction key
65: OK key
71 to 73: brightness distribution
80, 151: setting screen
90: guide information
101: body part
102: first member
103: second member
104: projection direction changing mechanism
105: shift mechanism
106: optical unit
111: increase key
112: decrease key
121: first optical system
D1: overlapping width
G1: image

What is claimed is:

1. A projection apparatus that projects a first image projected by a first projection portion and a second image projected by a second projection portion in a partially overlapping manner, the projection apparatus comprising:
a processor configured to perform a projection control on a first region of the first image set as an overlapping region with the second image and a second region of the second image set as an overlapping region with the first image,
wherein the processor is configured to:
in a case where a first operation of providing an instruction to collectively change a range of the first region in the first image and a range of the second region in the second image is received, perform a control of projecting the first image from the first projection portion by performing the projection control corresponding to the received first operation on the first region, and a control of projecting the second image from the second projection portion by performing the projection control corresponding to the received first operation on the second region; and
in a case where a second operation of providing an instruction to confirm the first region is received, finish the control corresponding to the first operation.

2. The projection apparatus according to claim 1,
wherein the projection control includes processing of decreasing brightness.

3. The projection apparatus according to claim 1,
wherein the processor is configured to:
perform a first projection control on the first region and perform a second projection control on the second region;
in a case where the first operation of providing the instruction to change the first region and the second region is received, perform the control of projecting the first image in which the first projection control is performed on the first region changed in accordance with the received first operation, from the first projection portion, and projecting the second image in which the second projection control is performed on the second region changed in accordance with the received first operation, from the second projection portion; and
in a case where the second operation of providing an instruction to confirm the first region and the second region is received, finish the control corresponding to the first operation.

4. The projection apparatus according to claim 3,
wherein the first projection control includes processing of setting a color of the first region to a first color, and
the second projection control includes processing of setting a color of the second region to a second color that is a complementary color to the first color.

5. The projection apparatus according to claim 1,
wherein the processor is configured to set the first region of the first image based on a positional relationship between a projection region of the first image and a projection region of the second image.

6. The projection apparatus according to claim 5,
wherein the processor is configured to set the positional relationship between the projection region of the first image and the projection region of the second image based on a user instruction.

7. The projection apparatus according to claim 5,
wherein the processor is configured to set the positional relationship between the projection region of the first image and the projection region of the second image based on imaging data of an imaging apparatus.

8. The projection apparatus according to claim 1,
wherein the processor is configured to perform a control of displaying guide information for providing a guide for a method of the first operation for each state of the projected first image and second image.

9. The projection apparatus according to claim 8,
wherein the processor is configured to perform a control of displaying the guide information by including the guide information in at least one of the first image or the second image.

10. The projection apparatus according to claim 1,
wherein the processor is configured to:
receive, from a user, combination information indicating partial overlapping between respective images projected by the first projection portion and the second projection portion among three or more projection portions including the first projection portion and the second projection portion; and
perform the control corresponding to the first operation for the first projection portion and the second projection portion based on the received combination information.

11. The projection apparatus according to claim 1,
wherein the processor is configured to control a region on which a projection control for the overlapping region is performed, for each combination of projection portions adjacent to each other among three or more projection portions including the first projection portion and the second projection portion based on a positional relationship of respective images projected by the three or more projection portions.

12. The projection apparatus according to claim 1,
wherein the second operation is an operation indicating that the first region matches the overlapping region between the first image and the second image.

13. A non-transitory computer readable medium storing a control program of a projection apparatus that projects a first image projected by a first projection portion and a second image projected by a second projection portion in a partially overlapping manner, the control program causing a processor of the projection apparatus to execute a process, the processor being configured to perform a projection control on a first region of the first image set as an overlapping region with the second image and a second region of the second image set as an overlapping region with the first image, the process comprising:
performing, in a case where a first operation of providing an instruction to collectively change a range of the first region in the first image and a range of the second region in the second image is received, a control of projecting the first image from the first projection portion by performing the projection control corresponding to the received first operation on the first region, and a control of projecting the second image from the second projection portion by performing the projection control corresponding to the received first operation on the second region; and
finishing, in a case where a second operation of providing an instruction to confirm the first region is received, the control corresponding to the first operation.

14. A projection apparatus that projects a first image projected by a first projection portion and a second image projected by a second projection portion in a partially overlapping manner, the projection apparatus comprising:
a processor configured to perform a projection control on a first region of the first image set as an overlapping region with the second image and a second region of the second image set as an overlapping region with the first image,
wherein the processor is configured to:
in a case where a first operation of providing an instruction to change the first region and the second region is received, perform at least one of: a control of projecting the first image from the first projection portion by performing the projection control corresponding to the received first operation on the first region; or a control of projecting the second image from the second projection portion by performing the projection control corresponding to the received first operation on the second region;
detect a positional relationship between a projection region of the first image and a projection region of the second image in accordance with the first operation that is received for a first time after the first image and the second image are projected, and set the first region of the first image based on the positional relationship; and
in a case where a second operation of providing an instruction to confirm the first region is received, finish the control corresponding to the first operation.

15. A projection method by a projection apparatus that projects a first image projected by a first projection portion and a second image projected by a second projection portion in a partially overlapping manner, the projection method comprising:
by a processor of the projection apparatus configured to perform a projection control on a first region of the first image set as an overlapping region with the second image and a second region of the second image set as an overlapping region with the first image,
performing, in a case where a first operation of providing an instruction to change the first region and the second region is received, at least one of: a control of projecting the first image from the first projection portion by performing the projection control corresponding to the received first operation on the first region; or a control of projecting the second image from the second projection portion by performing the projection control corresponding to the received first operation on the second region;
detecting a positional relationship between a projection region of the first image and a projection region of the second image in accordance with the first operation that is received for a first time after the first image and the second image are projected, and setting the first region of the first image based on the positional relationship;
finishing, in a case where a second operation of providing an instruction to confirm the first region is received, the control corresponding to the first operation.

16. A non-transitory computer readable medium storing a control program of a projection apparatus that projects a first image projected by a first projection portion and a second image projected by a second projection portion in a partially overlapping manner, the control program causing a processor of the projection apparatus to execute a process, the processor being configured to perform a projection control on a first region of the first image set as an overlapping region with the second image and a second region of the second image set as an overlapping region with the first image, the process comprising:
performing, in a case where a first operation of providing an instruction to change the first region and the second region is received, at least one of: a control of projecting the first image from the first projection portion by performing the projection control corresponding to the received first operation on the first region; or a control of projecting the second image from the second projection portion by performing the projection control corresponding to the received first operation on the second region;
detecting a positional relationship between a projection region of the first image and a projection region of the second image in accordance with the first operation that is received for a first time after the first image and the second image are projected, and setting the first region of the first image based on the positional relationship; and
finishing, in a case where a second operation of providing an instruction to confirm the first region is received, the control corresponding to the first operation.
